(19) United States
(12) Patent Application Publication
(10) Pub. No.: US 2024/0080711 A1
(43) Pub. Date: Mar. 7, 2024

(54) SYSTEM, METHOD, AND COMPUTER READABLE STORAGE MEDIUM

(71) Applicant: HONDA MOTOR CO.,LTD., Tokyo (JP)

(72) Inventors: Takahiro KUREHASHI, Saitama (JP); Moriya HORIUCHI, Saitama (JP); Yuta SAKAGAWA, Saitama (JP); Shigeru INOUE, Saitama (JP)

(21) Appl. No.: 18/450,424

(22) Filed: Aug. 16, 2023

(30) Foreign Application Priority Data
Sep. 7, 2022 (JP) 2022-142507

(51) Int. Cl. H04W 28/02

(52) U.S. Cl. CPC H04W 28/0289

(57) ABSTRACT

A system includes a first specifying unit which specifies, from among a plurality of areas, an area where a mobile communication terminal is present and a traffic risk is higher than a predetermined value, and an instruction unit which instructs, in order to cause a mobile object performing mobile communication with the mobile communication terminal to carry out the mobile communication of the mobile communication terminal, the mobile object to move to the area specified by the first specifying unit. A method includes specifying, from among a plurality of areas, an area where a mobile communication terminal is present and a traffic risk is higher than a predetermined value, and instructing, in order to cause a mobile object performing mobile communication with the mobile communication terminal to carry out the mobile communication of the mobile communication terminal, the mobile object to move to the area specified by the pacifying.

The contents of the following Japanese patent application(s) are incorporated herein by reference:
NO. 2022-142507 filed in JP on Sep. 7, 2022.

### TECHNICAL FIELD

The present invention relates to a system, a method, and a computer readable storage medium.

### BACKGROUND

In recent years, efforts have been intensified to provide access to a sustainable transportation system with consideration given to even vulnerable people among other traffic participants. To realize this, research and development has been focused on to further improve traffic safety and convenience through research and development regarding a preventive safety technique. Patent Document 1 describes a vehicle as a mobile relay device mediating wireless communication between a terminal and a base station.

### PRIOR ART DOCUMENT

Patent Document 1: Japanese Patent Application Publication No. 2021-097327

### BRIEF DESCRIPTION OF THE DRAWINGS

FIG. 1 shows an overall configuration of a system 10 according to an embodiment.

FIG. 2 illustrates a functional configuration of a server 40.

FIG. 3 illustrates a functional configuration of a mobile object 30.

FIG. 4 illustrates switching of a communication path.

FIG. 5 illustrates a flow of processings related to a method performed by the server 40, a mobile communication terminal 20, and a vehicle 60.

FIG. 6 illustrates a flow of processings related to a method performed by the server 40, the mobile communication terminal 20, and the mobile object 30.

FIG. 7 illustrates an example of a computer 2000.

### DESCRIPTION OF EXEMPLARY EMBODIMENTS

Hereinafter, embodiments of the present invention will be described. However, the following embodiments are not for limiting the invention according to the claims. In addition, not all combinations of features described in the embodiment are essential to the solution of the invention.

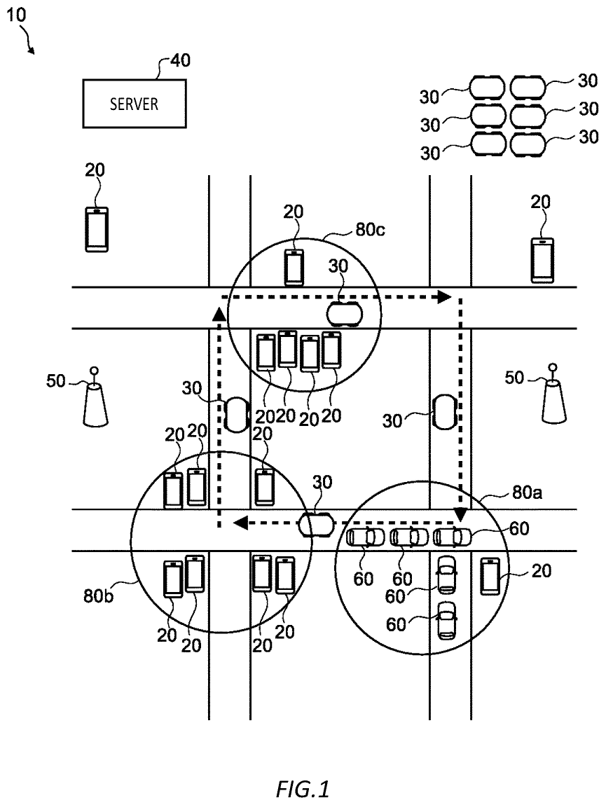

FIG. 1 shows an overall configuration of a system 10 according to an embodiment. The system 10 includes a server 40, a base station 50, a plurality of mobile objects 30, and a plurality of mobile communication terminals 20.

The base station 50 is a base station for mobile communication (also referred to as mobile object communication). The mobile communication terminal 20 is a terminal carried by a person, for example. The mobile communication terminal 20 is a portable terminal such as a smartphone, for example. The server 40 is a server that is communicably connected with the base station 50. The server 40 may include an edge computing server such as a mobile edge computing (MEC) server, for example.

The mobile communication terminal 20 and a vehicle 60 perform mobile communication through the base station 50 that is nearby, and communicate with the server 40. The server 40 continuously receives information representing a position and an advancing direction of each of the mobile communication terminal 20 and the vehicle 60. The server 40 receives information related to traveling control of the vehicle 60. The server 40 holds the information received from each of the mobile communication terminal 20 and the vehicle 60. The server 40 determines a traffic risk based on the information received from each of the mobile communication terminal 20 and the vehicle 60, and provides information related to the traffic risk to the mobile communication terminal 20 and the vehicle 60. For example, when the vehicle 60 is approaching the position where the mobile communication terminal 20 is present, the server 40 gives the mobile communication terminal 20 a notice to output a warning via the base station 50.

The server 40 specifies an area where the traffic risk is higher than a predetermined value based on information collected from the mobile communication terminal 20 and the vehicle 60. For example, based on the information collected from the mobile communication terminal 20 and the vehicle 60, the server 40 specifies an area 80a where rapid deceleration of the vehicle 60 occurs and the mobile communication terminal 20 is present, as the area where the traffic risk is higher than the predetermined value. Furthermore, the server 40 specifies an area 80b and an area 80c where a number of the mobile communication terminal 20 is greater than a predetermined value, as areas where a load of the mobile communication is large.

The server 40 moves the mobile object 30 having a function of providing mobile communication, to the area 80a, the area 80b, and the area 80c. For example, as shown with an arrow of a dotted line in FIG. 1, the server 40 instructs the mobile object 30 to move along a travel path passing the area 80a, the area 80b, and the area 80c, in this order.

The mobile object 30 is an automated-driving vehicle that travels by automated driving, for example. The mobile object 30 may be a passenger transport vehicle such as a taxi or a bus, a package transport vehicle that transports a package, or the like, for example. The mobile object 30 travels around the area 80a, the area 80b, and the area 80c by traveling according to a travel path instructed from the server 40.

The mobile object 30 has a function of a base station for mobile communication. The mobile object 30 performs mobile communication with the mobile communication terminal 20 and the vehicle 60. In this manner, the communication load of the mobile communication terminal 20 within the area 80b and the area 80c can be reduced. Furthermore, a communication delay of the mobile communication can be decreased by reducing the communication load of the mobile communication terminal 20 and the vehicle 60 in the area 80a where the traffic risk is high. Thus, it is possible to transmit the information related to the traffic risk to the mobile communication terminal 20 with a low delay. Accordingly, traffic safety within the area 80a can be enhanced.

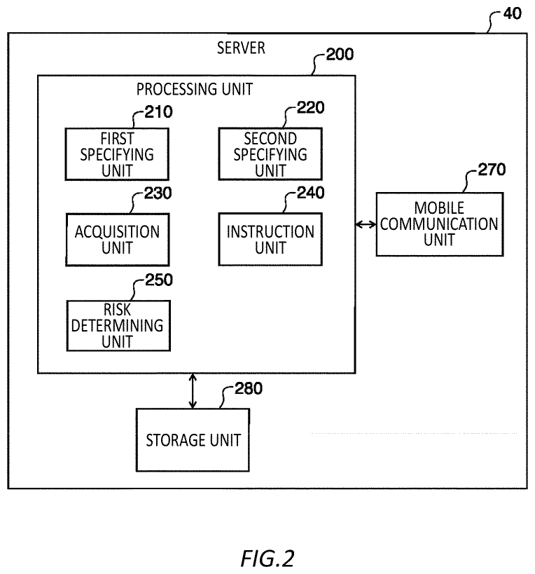

FIG. 2 illustrates a functional configuration of the server 40. The server 40 includes a processing unit 200, a storage unit 280, and a mobile communication unit 270. The processing unit 200 includes a first specifying unit 210, a second specifying unit 220, an acquisition unit 230, an instruction unit 240, and a risk determining unit 250.

The server 40 may be constructed by including a computer. The processing unit 200 may be implemented by a processor such as a CPU that performs calculation processing. The storage unit 280 may include a nonvolatile storage medium such as a flash memory or a volatile storage medium such as a random access memory. The mobile communication unit 270 may be implemented by a communication processor. The server 40 may perform various processing by causing the processing unit 200 to operate according to a program stored on a nonvolatile storage medium included in the storage unit 280.

The first specifying unit 210 specifies, from among a plurality of areas, an area where the mobile communication terminal 20 is present and a traffic risk is higher than a predetermined value. The first specifying unit 210 may specify at least one of an area where rapid deceleration of the vehicle 60 occurs, an area where a damage collision reducing brake of the vehicle 60 operates, an area where an inter-vehicle distance is shorter than a predetermined value, an area where a traveling speed of the vehicle 60 is higher than a predetermined value, or an area where traffic rule violation occurs, as the area where the traffic risk is higher than the predetermined value.

The instruction unit 240 instructs the mobile object 30 to move to the area specified by the first specifying unit 210 in order to cause the mobile object 30 having a function of performing mobile communication with the mobile communication terminal 20 to carry out the mobile communication of the mobile communication terminal 20.

The acquisition unit 230 acquires information representing positions and speeds of the plurality of the mobile communication terminals 20. The risk determining unit 250 determines, based on the information representing positions and speeds of the plurality of mobile communication terminals 20, whether there is a traffic risk in a position where each of the plurality of mobile communication terminals 20 is present. The mobile communication unit 270 functions as a transmitting unit which transmits the information related to the traffic risk to the mobile communication terminal 20 present at the position determined to have the traffic risk by the risk determining unit 250. The information related to the traffic risk may be information instructing the mobile communication terminal 20 to output a warning, for example.

The mobile object 30 has a function of receiving information representing positions and speeds of the plurality of mobile communication terminals 20, and a function of determining, based on the information representing positions and speeds of the plurality of mobile communication terminals 20, whether there is a traffic risk in a position where each of the plurality of mobile communication terminals 20 is present. The instruction unit 240 instructs the mobile object 30 to determine the traffic risk of the mobile communication terminal 20. The instruction unit 240 may further instruct the mobile communication terminal 20 determined to have the traffic risk to transmit the information related to the traffic risk. In this manner, since the traffic risk can be determined by the mobile object 30, a load of communication via the base station 50 and a load of a processing related to determination of the traffic risk can be reduced.

The second specifying unit 220 specifies a communication load of mobile communication for each of a plurality of areas, and specifies, from among the plurality of areas, an area where the communication load is higher than a predetermined value. For example, the second specifying unit 220 specifies the area where the load of the mobile communication is higher than the predetermined value based on at least one of (i) information on an event holding schedule or (ii) a congestion situation of the mobile communication terminal 20 inferred from history information of position information of the mobile communication terminal 20 received from the mobile communication terminal 20 or history information of at least one of dates, weathers, or time periods associated with the position information. The instruction unit 240 further instructs the mobile object 30 to move to the area specified by the second specifying unit 220 in order to cause the mobile object 30 to carry out the mobile communication of the mobile communication terminal 20. In this manner, it is possible to prevent occurrence of a large communication delay in an area where there is a high communication load.

The instruction unit 240 may instruct the mobile object 30 to travel around a route passing a plurality of areas specified by the first specifying unit 210. For example, the instruction unit 240 may instruct the plurality of mobile objects 30 having the function of performing the mobile communication with the mobile communication terminal 20 to travel around the route passing the plurality of areas specified by the first specifying unit 210.

The instruction unit 240 may specify one or more carriers providing mobile communication for the mobile communication terminal 20 present within the area specified by the first specifying unit 210, and instruct one or more of the mobile objects 30 providing the mobile communication of the one or more carriers specified by the instruction unit to move to the area specified by the first specifying unit 210.

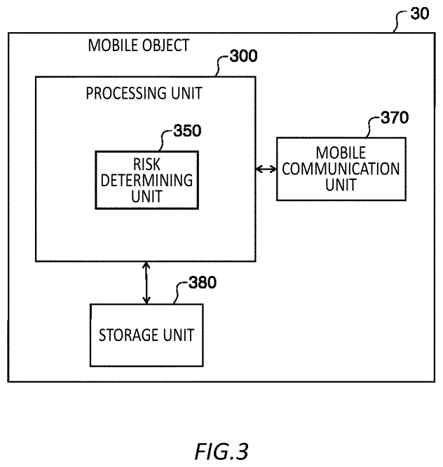

FIG. 3 illustrates a functional configuration of the mobile object 30. The mobile object 30 includes a processing unit 300, a storage unit 380, and a mobile communication unit 370. The processing unit 300 includes a risk determining unit 350.

The mobile object 30 may be constructed by including a computer. The processing unit 300 may be implemented by a processor such as a CPU that performs calculation processing. The storage unit 380 may include a nonvolatile storage medium such as a flash memory or a volatile storage medium such as a random access memory. The mobile communication unit 370 may be implemented by a communication processor. The mobile object 30 may perform various processings by causing the processing unit 300 to operate according to a program stored on a nonvolatile storage medium included in the storage unit 380.

The mobile communication unit 370 receives information representing positions and speeds of the plurality of mobile communication terminals 20. The risk determining unit 350 determines, based on the information representing positions and speeds of the plurality of mobile communication terminals 20, whether there is a traffic risk in a position where each of the plurality of mobile communication terminals 20 is present. The mobile communication unit 370 transmits the information related to the traffic risk to the mobile communication terminal 20 determined to be present in the position with the traffic risk by the risk determining unit 350. The information related to the traffic risk may be information instructing the mobile communication terminal 20 to output a warning, for example.

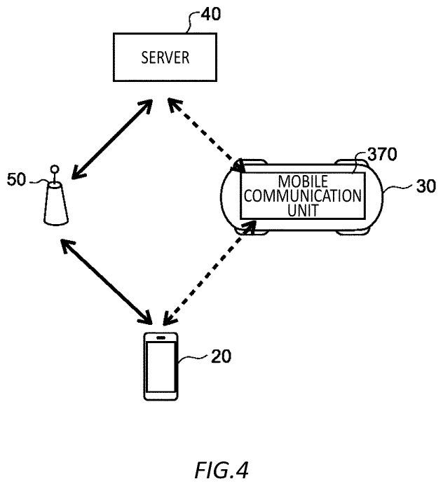

FIG. 4 illustrates switching of a communication path. When the mobile object 30 is not traveling nearby the mobile communication terminal 20, as shown with an arrow of a solid line in FIG. 4, the mobile communication terminal 20 and the server 40 communicate with each other through the base station 50.

On the other hand, when the mobile object 30 is traveling nearby the mobile communication terminal 20, as shown with an arrow of a broken line in FIG. 4, the mobile communication terminal 20 and the server 40 can communicate with each other through the mobile communication unit 370 included in the mobile object 30. In this manner, easy connection and a low delay can be achieved by reducing a communication load within the area 80. Furthermore, the mobile communication terminal 20 can receive the information related to the traffic risk determined by the risk determining unit 350 of the mobile object 30 from the mobile object 30. Therefore, the information related to the traffic risk can be provided to the mobile communication terminal 20 within the area 80 with a low delay.

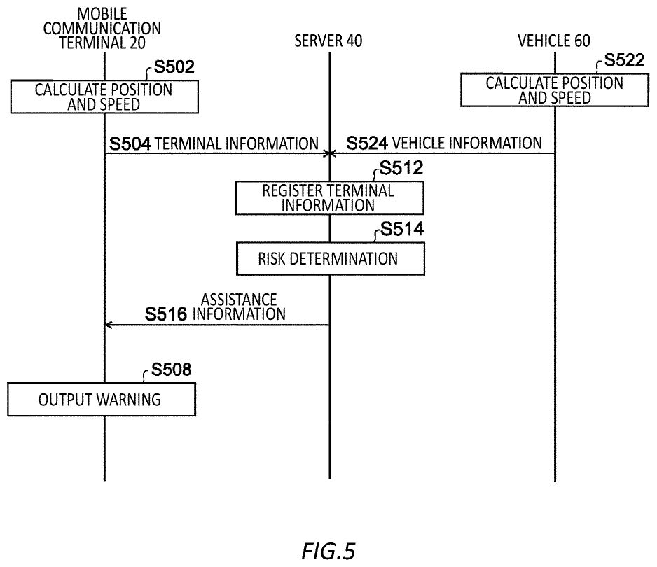

FIG. 5 illustrates a flow of processings related to a method performed by the server 40, the mobile communication terminal 20, and the vehicle 60. In S502, the mobile communication terminal 20 calculates a position and a speed. The mobile communication terminal 20 calculates a position of the mobile communication terminal 20 based on a signal received from a positioning satellite constituting a satellite positioning system (GNSS), for example. The mobile communication terminal 20 may calculate a moving speed of the mobile communication terminal 20 based on acceleration information obtained from an acceleration sensor included in the mobile communication terminal 20 and/or time change information of position information. The moving speed is information including an advancing direction and a speed of the mobile communication terminal 20. In S504, the mobile communication terminal 20 transmits information representing the position and the moving speed of the mobile communication terminal 20, and terminal information including identification information of the mobile communication terminal 20, to the server 40.

In S522, the vehicle 60 calculates a position and a moving speed. The vehicle 60 calculates a position of the vehicle 60 based on a signal received from a positioning satellite constituting a satellite positioning system (GNSS), for example. The vehicle 60 may calculate a moving speed of the vehicle 60 based on a vehicle speed sensor included in the vehicle 60, acceleration information obtained from an acceleration sensor included in the vehicle 60, and/or time change information of position information. The moving speed is information including an advancing direction and a speed of the vehicle 60. In S524, the vehicle 60 transmits information representing the position and the moving speed of the vehicle 60, information related to traveling control of the vehicle 60, and vehicle information including identification information of the vehicle 60, to the server 40.

In the server 40, once the mobile communication unit 270 receives the terminal information and the vehicle information, in S512, the storage unit 280 stores therein the position, the speed, and the identification information of the mobile communication terminal 20 received from the mobile communication terminal 20 in association with a time stamp. Furthermore, the storage unit 280 stores therein the vehicle information received from the vehicle 60 in association with a time stamp.

In S514, the risk determining unit 250 determines whether there is a traffic risk in a position where the mobile communication terminal 20 is present based on the terminal information and the vehicle information. For example, for each mobile communication terminal 20, the risk determining unit 250 determines whether there is any vehicle 60 that may reach the position of the mobile communication terminal 20 within a predetermined time, and if the vehicle 60 that may reach the position of the mobile communication terminal 20 within the predetermined time exists, determines that there is a traffic risk in the position where the mobile communication terminal 20 is present.

In S516, the mobile communication unit 270 transmits assistance information to the mobile communication terminal 20 determined to have the traffic risk. For example, the mobile communication unit 270 transmits the assistance information including an instruction to cause the mobile communication terminal 20 to output a warning. In S508, the mobile communication terminal 20 which received the assistance information outputs the warning. For example, the mobile communication terminal 20 outputs the warning by outputting a warning sound from the mobile communication terminal 20 and/or vibrating the mobile communication terminal 20 in a predetermined vibration pattern. In this manner, a user who is carrying the mobile communication terminal 20 outputting the warning can be made aware of the traffic risk.

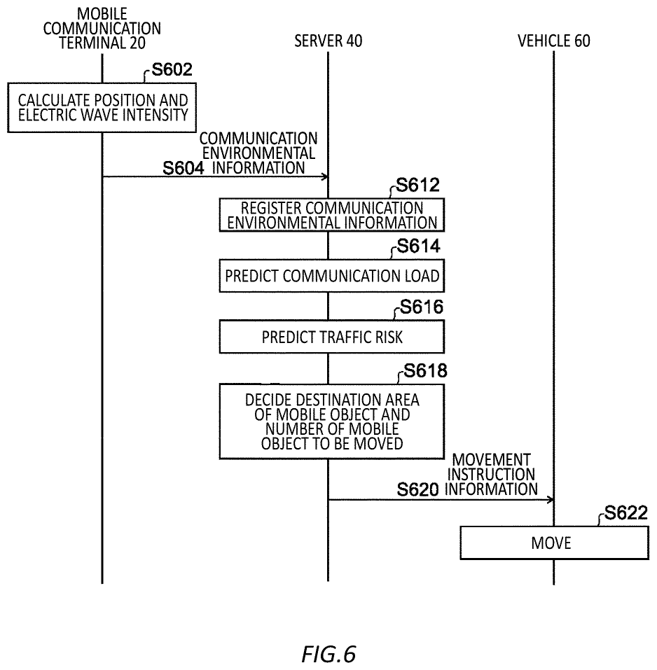

FIG. 6 illustrates a flow of processings related to a method performed by the server 40, the mobile communication terminal 20, and the mobile object 30. In S602, the mobile communication terminal 20 calculates a position of the mobile communication terminal 20 and a reception intensity of an electric wave received from the base station 50. In S604, the mobile communication terminal 20 transmits communication environmental information including information calculated in S602 and identification information of the mobile communication terminal 20, to the server 40.

In the server 40, once the mobile communication unit 270 receives the communication environmental information, in S612, the storage unit 280 stores therein the communication environmental information received from the mobile communication terminal 20 in association with a time stamp and weather information.

In S614, the second specifying unit 220 specifies an area that is predicted to have a communication load higher than a predetermined value based on the communication environmental information. For example, the second specifying unit 220 specifies the area predicted to have the communication load higher than the predetermined value based on at least one of a history of the position of the mobile communication terminal 20, a history of the reception intensity of the mobile communication terminal 20, or information on an event holding schedule. As an example, based on the information on the event holding schedule, when a predetermined event is to be held, the second specifying unit 220 predicts that a communication load will be high in a holding site of the event. Furthermore, the second specifying unit 220 specifies an area where a number density of the mobile communication terminal 20 becomes higher than a predetermined value based on a history of position information of the mobile communication terminal 20 associated with a time stamp and weather information, and a weather that is predicted for date and time that is the prediction target.

In S616, the risk determining unit 250 specifies an area where there is a traffic risk higher than a predetermined value based on the vehicle information and the terminal information of the mobile communication terminal 20 stored on the storage unit 280. The area where the traffic risk is higher than the predetermined value may be an area where rapid deceleration of the vehicle 60 occurs, an area where the damage collision reducing brake of the vehicle 60 operates, an area where an inter-vehicle distance is shorter than a predetermined value, an area where an average traveling speed of the vehicle 60 is higher than a predetermined value, or the like. The area where the traffic risk is higher than the predetermined value may be an area where a traffic rule violation occurs. The area where the traffic rule violation occurs may be an area where the vehicle 60 does not temporarily stop at a site where temporary stop is required, or an area where there is a crossing in a place other than a crosswalk. Whether an area is the area where there is a crossing in a place other than a crosswalk may be determined based on a history of a position and a speed of the mobile communication terminal 20 at a site where a crosswalk is set.

In S618, the instruction unit 240 generates instruction information including a destination area of the mobile object 30 and a number of the mobile object 30 to be moved. For example, the instruction unit 240 decides the area which is determined to have the communication load higher than the predetermined value in S614 to be the destination area. The instruction unit 240 decides the area which is determined to have the traffic risk higher than the predetermined value in S616 to be the destination area. The instruction unit 240 may decide the number of the mobile object 30 to be moved in accordance with a size of the communication load. The instruction unit 240 may decide the number of the mobile object 30 to be moved in accordance with a level of the traffic risk.

The instruction unit 240 may further decide a travel path that travels around a plurality of areas including the area which is determined to have the communication load higher than the predetermined value or the area which is determined to have the traffic risk higher than the predetermined value. The instruction unit 240 may decide the number of the mobile object 30 to be moved such that there is at least one mobile object 30 traveling within the plurality of areas. The instruction unit 240 may decide the number of the mobile object 30 to be moved in accordance with a length of the decided travel path.

In S620, the mobile communication unit 270 transmits, based on the information decided in S618, movement instruction information to the mobile object 30 so as to move the mobile object 30 to the destination area decided in S618. The movement instruction information may include information representing the destination area which is the area to which the mobile object 30 should be moved. The movement instruction information may include information representing the travel path of the mobile object 30. The mobile communication unit 270 may transmit the movement instruction information to the number of the mobile object 30 decided in S618.

In S622, upon receiving the movement instruction information from the server 40, the mobile object 30 moves to the destination area included in the movement instruction information. The mobile object 30 may perform traveling by traveling around along the travel path included in the movement instruction information. The mobile object 30 stops when a predetermined incident such as a traffic accident occurs, and may continue providing the mobile communication to the mobile communication terminal 20 and transmitting the information related to the traffic risk to the mobile communication terminal 20.

In S612 of FIG. 6, the second specifying unit 220 may specify, for each communication carrier, an area where a communication load is higher than a predetermined value. In S620, the instruction unit 240 may transmit the movement instruction information to the mobile object 30 that can provide mobile communication of a communication carrier in which the communication load is higher than the predetermined value. As an example, when the communication load of a first communication carrier and the communication load of a second communication carrier are higher than the predetermined value in a certain area, the movement instruction information may be transmitted so as to move a first mobile object 30 that can provide the mobile communication of the first communication carrier and a second mobile object 30 that can provide the mobile communication of the second communication carrier to that area.

In the embodiment as above, the mobile communication terminal 20 is described as a terminal carried by a person. However, the mobile communication terminal 20 may be provided to movable equipment other than a person. The mobile communication terminal 20 may be incorporated in the movable equipment. As an example, the mobile communication terminal 20 may be provided to the vehicle 60, and the function of the mobile communication terminal 20 may be incorporated in the vehicle 60.

As has been describe above, since the system 10 according to the present embodiment can move the mobile object 30 having the mobile communication function to the area where the traffic risk is high and the area where the communication load is high, the communication delay of the mobile communication in each area can be reduced. In this manner, in the area where the traffic risk is high, the information related to the traffic risk can be transmitted to the mobile communication terminal 20 with a low delay. Thus, traffic safety can be enhanced.

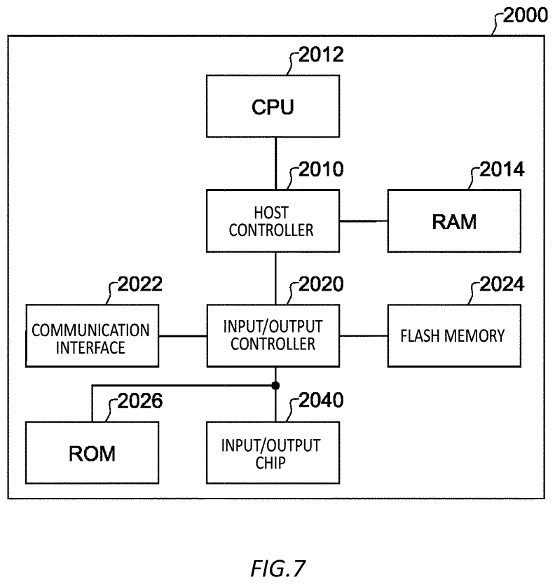

FIG. 7 illustrates an example of a computer 2000 in which a plurality of embodiments of the present invention may be entirely or partially embodied. A program installed in the computer 2000 can cause the computer 2000 to function as a system such as the server 40 according to an embodiment or each unit of the system, or an apparatus such as the mobile object 30 or each unit of the apparatus, execute operations associated with the system, each unit of the system, the apparatus, or each unit of the apparatus, and/or execute a process according to an embodiment or a stage of the process. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored on the ROM 2026 and the RAM 2014, and thereby controls each unit.

The communication interface 2022 communicates with other electronic devices via a network. The flash memory 2024 stores therein a program and data used by the CPU 2012 in the computer 2000. The ROM 2026 stores therein a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer readable storage medium such as a CD-ROM, a DVD-ROM, or a memory card. The RAM 2014, the ROM 2026, or the flash memory 2024 is an example of the computer readable storage medium. The program is installed in the flash memory 2024, the RAM 2014 or the ROM 2026 and executed by the CPU 2012. Information processing written in these programs is read by the computer 2000, and provides cooperation between the programs and the various types of hardware resources described above. An apparatus or a method may be actualized by executing operations or processing of information depending on a use of the computer 2000.

For example, when communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored on a recording medium such as the flash memory 2024 to be read into the RAM 2014, and execute various types of processing on the data on the RAM 2014. Next, the CPU 2012 writes back the processed data into the recording medium.

Various types of information such as various types of programs, data, a table, and a database may be stored on the recording medium and may be subjected to information processing. The CPU 2012 may execute, on the data read from the RAM 2014, various types of processing including various types of operations, information processing, conditional judgement, conditional branching, unconditional branching, information retrieval/replacement, or the like described in the present specification and specified by instruction sequences of the programs, and write back a result into the RAM 2014. In addition, the CPU 2012 may retrieve information in a file, a database, or the like in the recording medium. For example, when multiple entries, each having an attribute value of a first attribute associated with an attribute value of a second attribute, is stored on the recording medium, the CPU 2012 may retrieve an entry having a designated attribute value of the first attribute that matches a condition from the multiple entries, and read the attribute value of the second attribute stored in the entry, thereby obtaining the attribute value of the second attribute associated with the first attribute that satisfies a predefined condition.

The programs or software modules explained above may be stored on the computer readable storage medium on the computer 2000 or in the vicinity of the computer 2000. A recording medium such as a hard disk or a RAM provided in a server system connected to a dedicated communication network or the Internet can be used as the computer readable storage medium. A program stored on the computer readable storage medium may be provided to the computer 2000 via a network.

A program that is installed into the computer 2000 and makes the computer 2000 function as the server 40 may work on the CPU 2012 and the like to make the computer 2000 function as respective units of the server 40, respectively. The information processing written in these programs is read by the computer 2000 to function as each unit of the server 40 which is a specific means in which software and the above-described various hardware resources cooperate. Then, with these specific means, by achieving computing or processing of information according to an intended use of the computer 2000 in the present embodiment, the specific server 40 is constructed according to the intended use.

Various embodiments have been explained with reference to the block diagrams and the like. In the block diagrams, each block may represent (1) a stage of a process in which an operation is executed, or (2) each unit of the apparatus having a role in executing the operation. A specific stage and respective units may be implemented by a dedicated circuit, a programmable circuit supplied with computer-readable instructions stored on a computer readable storage medium, and/or a processor supplied with computer-readable instructions stored on a computer readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and other logical operations, and a memory element such as a flip-flop, a register, a field programmable gate array (FPGA), a programmable logic array (PLA), or the like.

The computer readable storage medium may include any tangible device capable of storing instructions to be executed by an appropriate device. Thereby, the computer readable storage medium having instructions stored therein forms at least a part of a product including instructions which can be executed to provide means for executing processing procedures or operations specified in the block diagrams. Examples of the computer readable storage medium may include an electronic storage medium, a magnetic storage medium, an optical storage medium, an electromagnetic storage medium, a semiconductor storage medium, and the like. More specific examples of the computer readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instruction may include an assembler instruction, an instruction-set-architecture (ISA) instruction, a machine instruction, a machine dependent instruction, a microcode, a firmware instruction, state-setting data, or either of source code or object code written in any combination of one or more programming languages including an object-oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, a special purpose computer, or other programmable data processing apparatus, or to programmable circuit, locally or via a local area network (LAN), wide area network (WAN) such as the Internet, and a computer-readable instruction may be executed to provide means for executing operations specified in the explained processing procedures or block diagrams. An example of the processor includes a computer processor, a processing unit, a microprocessor, a digital signal processor, a controller, a microcontroller, or the like.

While the present invention has been described with the embodiments, the technical scope of the present invention is not limited to the scope described in the above-described embodiments. It is apparent to persons skilled in the art that various alterations or improvements can be added to the above-described embodiments. It is also apparent from the description of the claims that the embodiments to which such alterations or improvements are made can be included in the technical scope of the present invention.

The operations, procedures, steps, and stages etc. of each process performed by an apparatus, system, program, and method shown in the claims, specification, or drawings can be executed in any order as long as the order is not indicated by “before”, “prior to”, or the like and as long as the output from a previous process is not used in a later process. Even if the operation flow is described using phrases such as “first” or “next” in the claims, specification, or drawings, it does not necessarily mean that the process must be performed in this order.

### EXPLANATION OF REFERENCES

10: system;
20: mobile communication terminal;
30: mobile object;
40: server;
50: base station;
60: vehicle;
80: area;
200: processing unit;
210: first specifying unit;
220: second specifying unit;
230: acquisition unit;
240: instruction unit;
250: risk determining unit;
270: mobile communication unit;
280: storage unit;
300: processing unit;
350: risk determining unit;
370: mobile communication unit;
380: storage unit;
2000: computer;
2010: host controller;
2012: CPU;
2014: RAM;
2020: input/output controller;
2022: communication interface;
2024: flash memory;
2026: ROM;
2040: input/output chip.

What is claimed is:

1. A system comprising:
a first specifying unit which specifies, from among a plurality of areas, an area where a mobile communication terminal is present and a traffic risk is higher than a predetermined value; and
an instruction unit which instructs, in order to cause a mobile object having a function of performing mobile communication with the mobile communication terminal to carry out the mobile communication of the mobile communication terminal, the mobile object to move to the area specified by the first specifying unit.

2. The system according to claim 1, wherein the first specifying unit specifies, as the area where the traffic risk is higher than the predetermined value, at least one of:
an area where rapid deceleration of a vehicle occurs,
an area where a damage collision reducing brake of a vehicle operates,
an area where an inter-vehicle distance is shorter than a predetermined value,
an area where a traveling speed of a vehicle is higher than a predetermined value, or
an area where traffic rule violation occurs.

3. The system according to claim 1, further comprising:
an acquisition unit which acquires information representing positions and speeds of a plurality of mobile communication terminals;
a risk determining unit which determines, based on the information representing positions and speeds of the plurality of mobile communication terminals, whether there is a traffic risk in a position where each of the plurality of mobile communication terminals is present; and
a transmitting unit which transmits information related to the traffic risk to a mobile communication terminal determined as having the traffic risk by the risk determining unit,
wherein the mobile object has a function of receiving the information representing positions and speeds of the plurality of mobile communication terminals, and determining, based on the information representing positions and speeds of the plurality of mobile communication terminals, whether there is a traffic risk in a position where each of the plurality of mobile communication terminals is present, and
the instruction unit instructs the mobile object to determine a traffic risk of the mobile communication terminal.

4. The system according to claim 1, further comprising a second specifying unit which specifies a communication load of the mobile communication for each of the plurality of areas and specifies, from among the plurality of areas, an area where the communication load is higher than a predetermined value, wherein
the instruction unit further instructs the mobile object to move to an area specified by the second specifying unit in order to cause the mobile object to carry out the mobile communication of the mobile communication terminal.

5. The system according to claim 4, wherein the second specifying unit specifies the area where the communication load of the mobile communication is higher than the predetermined value based on at least one of
(i) information on an event holding schedule, or
(ii) a congestion situation of the mobile communication terminal inferred from history information of position information of the mobile communication terminal received from the mobile communication terminal and history information of at least one of dates, weathers, or time periods associated with the position information.

6. The system according to claim 1, wherein
the instruction unit instructs the mobile object to travel around a route passing a plurality of areas specified by the first specifying unit.

7. The system according to claim 6, wherein
the instruction unit instructs a plurality of mobile objects having a function of performing mobile communication with the mobile communication terminal to travel around a route passing a plurality of areas specified by the first specifying unit.

8. The system according to claim 6, wherein
the instruction unit specifies one or more carriers providing mobile communication to the mobile communication terminal present within an area specified by the first specifying unit, and instructs one or more mobile objects providing the mobile communication of the one or more carriers specified by the instruction unit to move to the area specified by the first specifying unit.

9. The system according to claim 1, further comprising the mobile object.

10. The system according to claim 2, further comprising:
an acquisition unit which acquires information representing positions and speeds of a plurality of mobile communication terminals;
a risk determining unit which determines, based on the information representing positions and speeds of the plurality of mobile communication terminals, whether there is a traffic risk in a position where each of the plurality of mobile communication terminals is present; and
a transmitting unit which transmits information related to the traffic risk to a mobile communication terminal determined as having the traffic risk by the risk determining unit,
wherein the mobile object has a function of receiving the information representing positions and speeds of the plurality of mobile communication terminals, and determining, based on the information representing positions and speeds of the plurality of mobile communication terminals, whether there is a traffic risk in a position where each of the plurality of mobile communication terminals is present, and
the instruction unit instructs the mobile object to determine a traffic risk of the mobile communication terminal.

11. The system according to claim 2, further comprising a second specifying unit which specifies a communication load of the mobile communication for each of the plurality of areas and specifies, from among the plurality of areas, an area where the communication load is higher than a predetermined value, wherein
the instruction unit further instructs the mobile object to move to an area specified by the second specifying unit in order to cause the mobile object to carry out the mobile communication of the mobile communication terminal.

12. The system according to claim 3, further comprising a second specifying unit which specifies a communication load of the mobile communication for each of the plurality of areas and specifies, from among the plurality of areas, an area where the communication load is higher than a predetermined value, wherein
the instruction unit further instructs the mobile object to move to an area specified by the second specifying unit in order to cause the mobile object to carry out the mobile communication of the mobile communication terminal.

13. The system according to claim 10, further comprising a second specifying unit which specifies a communication load of the mobile communication for each of the plurality of areas and specifies, from among the plurality of areas, an area where the communication load is higher than a predetermined value, wherein
the instruction unit further instructs the mobile object to move to an area specified by the second specifying unit in order to cause the mobile object to carry out the mobile communication of the mobile communication terminal.

14. The system according to claim 11, wherein the second specifying unit specifies the area where the communication load of the mobile communication is higher than the predetermined value based on at least one of
(i) information on an event holding schedule, or
(ii) a congestion situation of the mobile communication terminal inferred from history information of position information of the mobile communication terminal received from the mobile communication terminal and history information of at least one of dates, weathers, or time periods associated with the position information.

15. The system according to claim 12, wherein the second specifying unit specifies the area where the communication load of the mobile communication is higher than the predetermined value based on at least one of
(i) information on an event holding schedule, or
(ii) a congestion situation of the mobile communication terminal inferred from history information of position information of the mobile communication terminal received from the mobile communication terminal and history information of at least one of dates, weathers, or time periods associated with the position information.

16. The system according to claim 2, wherein
the instruction unit instructs the mobile object to travel around a route passing a plurality of areas specified by the first specifying unit.

17. The system according to claim 3, wherein
the instruction unit instructs the mobile object to travel around a route passing a plurality of areas specified by the first specifying unit.

18. The system according to claim 16, wherein
the instruction unit instructs a plurality of mobile objects having a function of performing mobile communication with the mobile communication terminal to travel around a route passing a plurality of areas specified by the first specifying unit.

19. A method comprising:
specifying, from among a plurality of areas, an area where a mobile communication terminal is present and a traffic risk is higher than a predetermined value; and
instructing, in order to cause a mobile object having a function of performing mobile communication with the mobile communication terminal to carry out the mobile communication of the mobile communication terminal, the mobile object to move to the area specified by the specifying the area.

20. A non-transitory computer readable storage medium having stored thereon a program, the program causing a computer to function as:
a first specifying unit which specifies, from among a plurality of areas, an area where a mobile communication terminal is present and a traffic risk is higher than a predetermined value; and
an instruction unit which instructs, in order to cause a mobile object having a function of performing mobile communication with the mobile communication terminal to carry out the mobile communication of the mobile communication terminal, the mobile object to move to the area specified by the first specifying unit.
